(19) United States
(12) Patent Application Publication
(10) Pub. No.: US 2024/0326643 A1
(43) Pub. Date: Oct. 3, 2024

(54) SYSTEM FOR SUPPLYING A DELIVERY VEHICLE WITH ELECTRIC ENERGY, OPERATING METHOD, COMPUTER PROGRAM PRODUCT AND COMPUTER-READABLE DATA CARRIER

(71) Applicant: Ford Global Technologies, LLC, Dearborn, MI (US)

(72) Inventors: Bas van den Heuvel, Limburg (NL); Rob Stalman, Selfkant (DE); Mark Gijbels, Kessel-lo (BE); Martin Kapp, Dormagen (DE); Rainer Souschek, Aachen (DE)

(21) Appl. No.: 18/608,143

(22) Filed: Mar. 18, 2024

(30) Foreign Application Priority Data
Mar. 30, 2023 (DE) 102023108120.9

(51) Int. Cl. B60L 53/80; B60L 53/30; B60L 53/60

(52) U.S. Cl. CPC B60L 53/80; B60L 53/30; B60L 53/60

(57) ABSTRACT

A system for supplying a delivery vehicle with electric energy is described, which comprises an electrically drivable delivery vehicle for making a plurality of successive delivery journeys, in each case for transporting consignments on a respective delivery route from a starting point of the delivery route to recipients of the consignments, a supply vehicle for delivering replaceable battery modules to meeting points with the delivery vehicle, and a control device, which is designed to ascertain a likely energy requirement of the delivery vehicle for a subsequent delivery journey of the plurality of successive delivery journeys, taking into account a subsequent delivery route and a likely total weight of the delivery vehicle after loading consignments to be delivered on the subsequent delivery route at the starting point of the subsequent delivery route, and to prompt the supply vehicle to deliver a set of replaceable battery modules to a subsequent meeting point, which is the starting point of the subsequent delivery route, wherein the delivery vehicle has a first plurality of receiving units for replaceable battery modules for supplying the delivery vehicle with electric energy, and the set of replaceable batteries has a total charge level at the subsequent meeting point which covers at least the likely energy requirement and the set of replaceable battery modules has the lightest weight possible.

### CROSS-REFERENCE TO RELATED APPLICATIONS

The application herein asserts priority to and incorporates by reference German Application No. 102023108120.9, filed on Mar. 30, 2023.

### FIELD OF THE INVENTION

The present invention relates to a system for supplying a delivery vehicle, i.e. transport vehicle, with electric energy and a method for operating a control device of such a system and a computer program product and a computer-readable data carrier.

### BACKGROUND

Electric vehicles are vehicles driven by electric energy. Vehicles which are driven by electric energy in only one of a plurality of operating states, e.g. hybrid vehicles (HEVC), are also referred to as electric vehicles here, as are vehicles which use an electric energy source entirely or in part as an auxiliary energy source in addition to another drive energy source, for example cargo bikes with an auxiliary motor.

Many electric vehicles, including small electric vehicles, are equipped with large, heavy and expensive batteries as electric energy stores-even when it would be sufficient to equip the vehicles with smaller, less powerful batteries with a smaller electric storage capacity for the journeys for which they are intended. This is because a plurality of these journeys often have to be completed one after another on the same day—for example in the case of delivery vehicles—with no guarantee that the electric drive battery of the electric vehicle can be charged between journeys, for example due to a lack of charging stations or busy charging stations or due to a shortage of time for charging the drive battery. Drive batteries which can provide sufficient capacity for a maximal number of expected journeys, but are therefore oversized if the number of required journeys is normally less than the maximal number, are frequently used, which means that the energy efficiency drops in these cases since the batteries in these cases are unnecessarily heavy, expensive and large and there is less space remaining for a vehicle load. Moreover, in the case of batteries with a high capacity, there is still the uncertainty as to whether the energy provided is actually sufficient, for example since journeys may prove to be longer than expected, e.g. due to unplanned diversions.

If replaceable batteries are used, a long standing time for charging the batteries can be avoided. However, if these replaceable batteries are charged in stationary battery depots and made available for collection, this limits the possible travel-route planning of the vehicles since the route has to be configured so that a depot is located within a range of the vehicle which enables the depot to be reached on the remaining electric energy. Establishing and operating a depot infrastructure would be expensive and would require multiple sites, which are expensive and require space for parking and a suitable connection to a grid, e.g. a national grid. An extensive depot infrastructure may be avoided in that supply vehicles deliver sufficiently charged replaceable batteries to flexibly selectable meeting points in order to deliver them to electrically driven vehicles which need a battery replacement, wherein the supply vehicle collects the replaceable batteries beforehand from a charging station or carries out the charging procedure using on-board means.

A system for coordinating battery replacement in electric vehicles is described, for example, in U.S. Pat. No. 11,097,632 B2. In this, a requesting electric vehicle which uses replaceable batteries as an energy source contacts a server, via which a supply vehicle, i.e. a service vehicle, is instructed to deliver suitable, sufficiently charged batteries to the requesting electric vehicle. The supply vehicle delivers batteries which have either been charged via a generator or a solar panel at a charging station or during the journey. Parameters of the requesting electric vehicle and the service vehicles are taken into account when specifying which supply vehicle is contacted and which batteries are delivered.

U.S. Pat. No. 9,007,020 B2 describes a system in which technical rescue vehicles have on-board charging stations via which electric vehicles may be charged as needed. To operate these mobile charging stations, the technical rescue vehicles carry battery modules, which they either charge themselves or which have been charged beforehand at a stationary charging station and which can be delivered by a supply vehicle.

CN 114 580 984 B presents a system for mobile replacement of drive batteries of electric vehicles and a time-planning method which specifies when a supply vehicle should deliver charged replacement batteries to electrically operated utility vehicles, in particular on a travel route in a mining area. This takes into account various parameters, for example the charge level of the batteries, remaining driving distances for the utility vehicles and the current position of the supply vehicle.

GB 2 579 243 A describes a vehicle chassis which has recesses which form insertion spots for vehicle components, in particular batteries.

U.S. Pat. No. 11,407,526 B2 describes a system in which an unmanned aerial vehicle, which may communicate with a vehicle and may also be configured for transporting a payload, may land on a docking station on the vehicle. Provision may be made here to charge the battery of the unmanned aerial vehicle via the docking station. The unmanned aerial vehicle may also have replaceable battery modules, which may be changed automatically in the docking station.

In particular in the case of small delivery vehicles which serve as final delivery vehicles for delivering consignments, e.g. ordered parcels or goods, directly to the final recipient—for example on travel routes through urban neighborhoods of a city—the possible vehicle load capacity for consignments to be transported is limited, which means that as little space as possible should be used for the batteries which function as the electric drive energy source and also need to be transported, and the efficiency with which the available energy is used should not be reduced as a result of transporting unnecessary weight for an electric energy storage capacity, i.e. battery storage capacity, which is not used during the journey. Such a final delivery vehicle may be, for example, a cargo bike with an electric drive motor or any other delivery vehicle which is suitable for the “last mile” to the recipient, e.g. an electric moped or motorbike, a delivery van, a light electric freight vehicle or another electrically drivable transport vehicle (including a suitable passenger transport vehicle, as explained further below).

### SUMMARY

The present invention is based on the object of providing an option for supplying an electrically driven delivery vehicle with sufficient electric energy on any of a series of delivery journeys in a cost-effective and particularly energy-efficient manner.

This object is achieved according to the invention by a system for supplying a delivery vehicle with electric energy according to the claims, and a method for operating a control device of a system for supplying a delivery vehicle with electric energy according to the claims, a computer program product according to the claims and a computer-readable data carrier according to the claims. Advantageous developments of the invention are specified in the dependent claims.

According to a first aspect of the invention, a system for supplying a delivery vehicle with electric energy comprises an electrically drivable delivery vehicle for making a plurality of successive delivery journeys, in each case for transporting consignments on a respective delivery route from a starting point of the delivery route to recipients of the consignments, a supply vehicle for delivering replaceable battery modules to meeting points with the delivery vehicle and a control device, which is designed to ascertain a likely energy requirement of the delivery vehicle for a subsequent delivery journey of the plurality of successive delivery journeys, taking into account a subsequent delivery route and a likely total weight of the delivery vehicle after loading consignments to be delivered on the subsequent delivery route at the starting point of the subsequent delivery route, and to prompt the supply vehicle to deliver a set of replaceable battery modules to a subsequent meeting point, which is the starting point of the subsequent delivery route. Provision is made here for the delivery vehicle to have a first plurality of receiving units for replaceable battery modules for supplying the delivery vehicle with electric energy and for the set of replaceable battery modules to have a total charge level at the subsequent meeting point which covers at least the likely energy requirement and for the set of replaceable battery modules to have the lightest weight possible.

Therefore, not only is provision made to transfer charged replaceable battery modules to the delivery vehicle before the start of each subsequent delivery journey, but the likely energy requirement for merely a subsequent delivery journey in each case is ascertained at the start of this subsequent delivery journey, taking into account the subsequent delivery route in each case, i.e. the subsequent travel route, i.e. the subsequent driving distance, and the likely total weight of the delivery vehicle, i.e. the weight of the delivery vehicle including the driver and the consignment to be delivered and the battery module for the subsequent delivery journey, and the supply vehicle delivers the battery module or the combination of battery modules which are suitable for the receiving units for battery modules of the delivery vehicle and can cover the ascertained likely energy requirement whilst having a minimal weight so that the actual carrying of the set of battery modules by the delivery vehicle calls for no more energy than is absolutely necessary. If all the replaceable battery modules available for the system have the same weight, only the minimally required number of modules likely to be needed for completing just the subsequent delivery journey is taken on board the delivery vehicle. The replaceable battery modules required for the subsequent delivery journey in each case may be supplied at any desired meeting point as a starting point of the subsequent delivery route which may not only be reached by the delivery vehicle but also by the supply vehicle and where the loading of the consignments for the subsequent delivery journey may take place. In particular, the meeting points are not limited by the existing grid and the availability of charging stations for the battery modules. This is, for example, advantageous for delivery vehicles which are provided for the final delivery of consignments to the final recipient in an urban environment, where small delivery vehicles have advantages over larger delivery vehicles due to the road conditions and the available space, the high traffic volume and the parking situation, for example.

Provision is preferably made not only for the requested set of replaceable battery modules to be transferred from the supply vehicle to the delivery vehicle at the respective meeting point but for the supply vehicle to also take the set of replaceable battery modules used on the previous delivery journey from the delivery vehicle at this meeting point and to instigate electrical recharging on board or transport them to a charging station.

The number of receiving units which make up the first plurality of receiving units for replaceable battery modules may be specified by an operator of the delivery vehicle depending on the area of use of the delivery vehicle. For example, an electric energy requirement for a maximally possible delivery journey length in the planned area of use may define the maximally required number of replaceable battery modules and receiving units required for these battery modules.

Although consignments, i.e. items to be transported, generally refer to goods or parcels here, they also refer to objects or items to be transported in general, and a delivery vehicle is a vehicle designed to transport them. However, in one embodiment, this may also relate to people, wherein the delivery vehicle in this case is designed as an electrically driven passenger vehicle and refers, for example, to an electrically driven taxi, a minibus or other passenger vehicle, i.e. a vehicle suitable for conveying people. In another embodiment, a delivery vehicle may refer to a transport vehicle in general, for example a vehicle of a tradesperson which transports equipment to and from customers as recipients.

Taking a subsequent delivery route into account when ascertaining the likely energy requirement includes, in particular, taking into account the length of the covered route, but may moreover include taking into account further parameters, for example depending on the environment through which the travel route runs, the uphill and downhill gradients along the route, the curve radii, the road surface, the wind conditions, the expected traffic volume, the possible waiting times at traffic lights or in traffic jams, etc.

Battery modules are or include rechargeable batteries, i.e. accumulators, or other rechargeable electric energy stores, e.g. storage capacitors, and connections or interfaces in order to be able to produce electrical connections with the electric drive system of the delivery vehicle in receiving units, i.e. slots. The receiving units are preferably designed to fix replaceable battery modules securely in position, and therefore form a holder so that a stable mechanical connection is produced in addition to the electrical connection. The connection provided is preferably a quick connect and release connection to enable quick and easy latching and unlatching of the battery module or quick and easy connection and disconnection. For quick and safe handling by a user, in particular a driver of the supply vehicle or the delivery vehicle, the replaceable battery modules have one or more handles. The receiving units and battery modules or at least the required connecting elements and interfaces may be standardized in order to enable the battery modules to be switched between different delivery vehicles.

The first plurality of receiving units, i.e. slots, may be arranged in an undercarriage under a cargo area for consignments, in the cargo area and/or in other positions in the delivery vehicle.

A set of replaceable battery modules comprises one battery module or multiple battery modules. The lightest possible weight of the set of replaceable battery modules in each case depends, amongst other things, on the electric storage capacity and the storage technology used by the individual battery modules which can be delivered by the respective supply vehicle. In one embodiment, the system for supplying a delivery vehicle with electric energy also comprises the set of replaceable battery modules. In a preferred embodiment, the system comprises all suitable replaceable battery modules which can be delivered by the supply vehicle. The set of replaceable battery modules which are delivered to the subsequent meeting point in each case represents a current set of replaceable battery modules. Provision is made for the set of replaceable battery modules which was previously used by the delivery vehicle to be exchanged for the currently delivered set at the meeting point, i.e. provision is made for the subsequent delivery journey in each case proceed on the subsequent, i.e. upcoming, delivery route, i.e. the subsequent travel route, using the newly delivered set of replaceable battery modules in each case.

The set of replaceable battery modules which is delivered to the subsequent meeting point by the supply vehicle has a total charge level which will cover the likely energy requirement for the subsequent delivery journey, i.e. the subsequent delivery journey of the plurality of delivery journeys. The result of an approximate calculation based on the available parameter values represents the likely energy requirement. However, if it is established when making the respective delivery journey that the total charge level is insufficient, for example because it was necessary to make a brief detour from the basic travel route, the weather conditions resulted in an unexpectedly high energy consumption or the weight of the vehicle did not decrease as expected over the course of the journey since heavy consignments could not be unloaded in the case of one or more recipients, the system is designed such that the control device specifies a new meeting point as the subsequent meeting point between the delivery vehicle and the supply vehicle. With the proposed system, it is therefore unnecessary to always provide a sufficiently high additional quantity of reserve electric energy. In particular, it is still possible to request the set of replaceable battery modules with the lightest weight possible for covering the likely energy consumption if a reserve, or only a small reserve, of additional electric energy is provided, which means that the necessary energy requirement may be efficiently covered by a set of battery modules which have the lightest weight possible and therefore require the lowest possible energy consumption for their own transportation.

A delivery route has a planned starting point and a planned end point. This may be the starting point again, although it doesn't have to be and may instead be flexibly specified provided it may be reached by the supply vehicle. In one embodiment, a suitable optimal meeting point at which one delivery route ends and which serves as a starting point for the subsequent delivery route in each case is calculated by the control device. This is ascertained taking into account the position and the remaining electric energy of the delivery vehicle and the position of the supply vehicle as well as the charge level of the replaceable battery modules needed for the subsequent delivery route and the availability of these battery modules in the supply vehicle. This route planning may be planned in advance by the control device, but may also be flexibly ascertained in real time in the case of a wireless connection between the vehicles and the control device. In particular, in some embodiments, a booking service may moreover be provided, via which recipients may, for example, influence a delivery, e.g. cancel, reschedule or divert a delivery or give advance notification of items to be returned by the delivery vehicle so that it may be necessary or expedient for the control device to be able to flexibly adapt the delivery journey or the delivery route.

The control device comprises at least one programmable unit, e.g. a processor or micro-controller, and has a memory and interfaces for receiving the relevant data for the subsequent journey in each case and for transmitting ascertained control demands to the delivery vehicle and the supply vehicle. In one embodiment of the system, the control device is arranged on board the delivery vehicle. In another embodiment, the control device is arranged on board the supply vehicle. And in a further embodiment, the control device is arranged separately from both the delivery vehicle and the supply vehicle. Provision is made for the interfaces to be configured for wireless communication with the respective remote vehicles of the system, wherein the vehicles likewise each have necessary corresponding interfaces for wireless communication.

In one embodiment, provision is made for the control device to provide its functionality via a cloud computing service. A cloud computing service provides IT data processing infrastructure means via a data network, in particular the Internet, as a service, for example storage space, computing power and/or certain user software, for which the cloud computing service is executed on one or more data processing infrastructure devices in the form of computers, data processing systems or other programmable devices with a processor and memory which have one or more connections to at least one data network via a wireless network interface via which the cloud computing service may be accessed and via which the cloud computing service enables programs executed thereby to access the data network, for example.

In one embodiment of the system for supplying a delivery vehicle with electric energy, the supply vehicle is designed to also deliver at least some of the consignments which are to be delivered on the subsequent delivery route of the delivery vehicle. In other words, not only does the supply vehicle deliver the requested set of replaceable battery modules to the subsequent meeting point, but it also delivers all or at least some of the consignments to be delivered to the recipient by the delivery vehicle on the subsequent delivery journey. The delivery vehicle as the final delivery vehicle can thus be supplied with replacement battery modules in a particularly efficient manner since the delivery of the consignments to the subsequent meeting point, i.e. the starting point of the subsequent delivery journey, by a further transport vehicle may be avoided entirely or the demands on the transport vehicle may be reduced since fewer items are to be transported thereby. The further transport vehicle may also be the delivery vehicle itself, for example, if second delivery attempts are to be made for consignments which were not delivered on the current, i.e. last, delivery route.

In an exemplary embodiment, the supply vehicle has a second plurality of receiving units for replaceable battery modules, i.e. both the delivery vehicle and the supply vehicle are able to transport multiple replaceable battery modules incorporated in receiving units via which an electrical connection is also produced, which may serve, for example, for charging the battery modules whilst they are on board the supply vehicle. This second plurality of further receiving units, i.e. slots, may be arranged, for example, in the undercarriage of the supply vehicle, e.g. outside the cargo area of the supply vehicle.

The charging of replaceable battery modules on board the supply vehicle may take place, for example, during the journey, e.g. by converting kinetic energy of the vehicle into electric energy during regenerative braking. When the supply vehicle is stationary, it may also be connected to a stationary charging station in order to charge the battery via a stationary energy store or a grid, e.g. a national grid.

In an embodiment of the system for supplying a delivery vehicle with electric energy, the supply vehicle has a charging device, which is designed to charge replaceable batteries with electric energy during the journey and when the supply vehicle is stationary. This has the advantage, for example, that the charging of the battery modules may be timed such that they have the required charge when transferred at the respective meeting point with the delivery vehicle, whilst the time taken to drive to the meeting point may be used as time for charging. The charging of the discharged battery modules taken from the delivery vehicle may equally begin as soon as they are taken on board the supply vehicle. Therefore, depending on the type of charging device, it is possible to achieve independence from stationary charging stations or the grid or, if the supply vehicle needs to be temporarily connected to a stationary charging station or to the grid in order to charge the on-board charging device, the standing time is reduced and the time for which the supply vehicle is available for supply journeys is increased. The charging device may comprise, for example, a battery which is carried on board the supply vehicle, for example a high-voltage battery with a high storage capacity, which thus serves as a mobile charging station and charges the replaceable battery modules on board during the journey or even when stationary. The charging device may also additionally or instead comprise a photovoltaic system with a solar panel on board the supply vehicle, for example.

In an embodiment of the system for supplying a delivery vehicle with electric energy, the supply vehicle has a fuel cell device and is designed to generate electric energy via the fuel cell device to charge the replaceable battery modules. The fuel cell device comprises, or is connected to, a storage device, preferably for hydrogen. The use of a fuel cell device on board the supply vehicle enables the replaceable battery module to be charged completely independently of stationary charging stations or the grid, i.e. the national grid. On the one hand, the spatial requirement of a fuel cell device is smaller than that of a comparably powerful battery; on the other, refueling at an appropriately suitable hydrogen filling station can be carried out more quickly than recharging a battery with a comparable capacity, which means that the daily standing time required for this is reduced and the readiness of the supply vehicle for use is increased. If the supply vehicle is configured to transport both replaceable battery modules and consignments to meeting points with delivery vehicles, i.e. final delivery vehicles, the hydrogen filling station may be located, for example, at the loading site of the supply vehicle, for example on company premises, in the vicinity of a parcel distribution center etc., depending on the type of consignments.

In one embodiment, the supply vehicle is a fuel cell vehicle (FCEV) and is itself powered by this fuel cell device or a further fuel cell device. Depending on the embodiment, provision may be made for the fuel cell device to be designed to charge an electric energy store of the charging device or to charge the replaceable battery modules directly. If the supply vehicle is driven by the same fuel cell device with which the replaceable battery modules to be transported are also charged, the electric energy generated over and above that needed to drive the vehicle is available for charging the replaceable battery modules. The supply vehicle may have an on-board battery in order to match the energy requirement for driving the vehicle to the progression of the energy generation by the fuel cell device. In an embodiment of the system, provision is made for a separate battery to not be provided for this; instead, this function is provided by one or more of the replacement battery modules to be transported. An additional reduction in weight and costs may thus be achieved, and the energy efficiency of the system further improved.

In yet another embodiment, provision is made for the supply vehicle to also be configured as a mobile charging station, which provides an output interface via which electric energy generated by the fuel cell device or other on-board charging device may be output into a national or company-owned grid on site, for example during relatively long standing times, e.g. when parking overnight on company premises. Therefore, the supply vehicle may also serve, for example, as an energy buffer or emergency power unit for a local, e.g. company-owned, grid. Provision may also be made for the supply vehicle to be designed to transport cooled goods as consignments and for the cooling to not only be maintained during the journey, but also when stationary, for example overnight, using the fuel cell device or another on-board charging device. Therefore, there is also the option of loading and temporarily storing cooled goods before the delivery on the following day without interrupting the cooling process.

In a further embodiment of the system for supplying a delivery vehicle with electric energy, the replaceable battery modules are of a similar standard type, i.e. the battery modules used have similar dimensions, similar connections, i.e. connecting elements, and preferably also a similar electric storage capacity. The receiving units for the replaceable battery modules are preferably also standardized. It is thus ensured that it is possible to switch the battery modules between different delivery vehicles. Provision may be made here for the different types of delivery vehicles to differ in terms of the number of available receiving units. Therefore, cargo bikes with an electric motor may provide a different number of receiving units for replaceable battery modules compared to a scooter or a light electric freight vehicle (LEFV), for example. In a further embodiment, provision may be made for the same standard type of replaceable battery modules to also be used in other electrically operated devices, for example for electrically operated tools, garden equipment etc. The system may thus also enable a delivery service for delivering replaceable battery modules to recipients.

In an embodiment of the system, the supply vehicle is designed to deliver replaceable battery modules to at least one further delivery vehicle, i.e. it is designed so that a correspondingly greater number of battery modules may be brought along and, depending on the embodiment, charged during the journey, for which a sufficiently large number of receiving devices for mobile battery modules are provided on board the supply vehicle.

In a further embodiment of the system for supplying a delivery vehicle with electric energy, provision is made for the set of replaceable battery modules to be operable in a low voltage range, i.e. in a range with a low output voltage and high output current. The output voltage of the set here refers to the total voltage at the output, wherein the individual voltages at the individual battery modules of the set may differ depending on the interconnection. The set of replaceable battery modules in the low voltage range preferably delivers an output voltage of no more than 60 volts, for example 48 volts. The operation of delivery vehicles with battery sets in the low voltage range is sufficient since the battery sets only have to be sufficiently dimensioned for one delivery journey and not for operating over a plurality of delivery journeys. Operation in the low voltage range instead of in a high voltage range increases the operational safety. Moreover, this may reduce the complexity and lower costs, for example since lower demands are placed on components of the electrical system of the delivery vehicles. A suitable replaceable battery module may have an energy storage capacity of preferably no more than 2 kilowatt hours (kWh), for example 1.5 kilowatt hours.

In a further embodiment of the system for supplying a delivery vehicle with electric energy, the control device is designed to create the set of replaceable batteries taking into account the optimization of the battery life of the replaceable battery modules. To this end, provision is made for the control device to manage the charge of the battery modules. This includes, for example, creating the set of replaceable battery modules from battery modules of which as many as possible, preferably all, are charged so that they may each be operated in the charge level range which is most suitable for them. For example, the suitable charge level ranges may differ and vary depending on the battery type, age and number of previous charges. Instead, or in addition, the optimization of the battery life of the battery modules may include charging and creating the battery module sets such that the individual remaining battery lives of all the available battery modules decrease uniformly.

In one embodiment, the system moreover comprises at least one further electrically drivable delivery vehicle for making a further plurality of successive delivery journeys, in each case for transporting further consignments to further recipients of the further consignments on a respective further delivery route from a further starting point of the further delivery route. In yet another embodiment, the system moreover comprises at least one further supply vehicle for delivering further replaceable battery modules to further meeting points with the delivery vehicle and/or the at least one further delivery vehicle.

In an exemplary embodiment, the control device is then also designed to manage the assignment of battery modules to vehicles of the system, for example to the delivery vehicle, the at least one further delivery vehicle, the supply vehicle and the at least one further supply vehicle. Based on at least the current charge levels of the replaceable battery modules available in the system and the delivery routes ascertained for the different delivery vehicles or the geographical positions of the delivery vehicles and their distances from the subsequent meeting points, the battery module assignment management determines which replaceable battery module shall be transferred to which of the different supply vehicles so that it can be delivered on time and with sufficient charge to a further one of the delivery vehicles at one of the meeting points.

The control device may also comprise multiple control units, for example an additional unit for the battery assignment management and/or battery module charge management. The control units of the control device may be arranged at different points in the system.

In a further embodiment of the system for supplying a delivery vehicle with electric energy, the delivery vehicle has, in addition to the first plurality of receiving units for replaceable battery modules for supplying the delivery vehicle with electric energy, at least one additional receiving unit for replaceable battery modules. In a fleet of multiple delivery vehicles, an additional replaceable battery module may thus be carried in the additional receiving unit, i.e. an additional slot, which battery module may possibly be transferred to another delivery vehicle—e.g. in the event that the other delivery vehicle, due to the unscheduled premature discharge of its battery modules, is stuck in an area to which the supply vehicle is unable to travel—for example, a cargo bike with an electric auxiliary motor in a pedestrian zone which is open to cargo bikes, or the like. This increases the certainty that a charged battery may always be brought to a delivery vehicle to enable it to reach a recipient or arrive at a subsequent meeting point with a supply vehicle, even if the electric energy storage capacity provided on board the delivery vehicle has been calculated with a narrow margin so that a set of replaceable battery modules with the lightest total weight possible can be used, thereby avoiding weight and costs and increasing the energy efficiency. In one embodiment, such additional battery modules (“emergency modules”) may be of a particularly small, light design, for example, and serve predominantly to provide additional energy for a short distance, for example to reach the next road which can also be accessed by supply vehicles.

In a further embodiment of the system, the delivery vehicle has a cargo area for receiving the consignments and at least one of the first plurality of receiving units for replaceable battery modules is arranged in the cargo area. The term “cargo area” here relates, in general, to each cargo facility intended for transporting consignments, even if it is not an enclosed space. In this sense, for example, a load bed is also a “cargo area” if consignments can be transported thereon during the journey and the receiving unit arranged “in” the cargo area may also be arranged “on” the load bed.

In an exemplary embodiment, the system for supplying a delivery vehicle with electric energy comprises at least one transport device for consignments, wherein the at least one transport device is designed to be received in the cargo area and has an integrated battery module unit, which has a first interface to be received in the least one of the first plurality of receiving units for replaceable battery modules, which receiving unit is arranged in the cargo area. Systems for supplying a delivery vehicle with electric energy which do not have the control device, and electrically driven delivery vehicles which do not belong to the system, may also have a transport device according to the described embodiment. Like a replaceable battery module, the battery module unit of the transport device may, amongst other things, be electrically connected to the receiving unit for replaceable battery modules which is arranged in the cargo area, and, like a replaceable battery module, it may provide electric energy for driving the delivery vehicle.

A transport device for consignments is, for example, a transport container or a transport cart, i.e. a trolley, which may be moved, for example, using muscle power or via an integrated electric auxiliary motor, wherein provision may be made, for example, for the integrated battery module unit to also provide the electric energy for operating the auxiliary motor. In a preferred embodiment, the transport device is a transport cart and the cargo area of the delivery vehicle is designed to enable direct loading and unloading using the transport cart. In a particularly preferred embodiment, the cargo area is designed such that direct cross-loading of the transport cart between a cargo area of the delivery vehicle and a further transport vehicle, for example the supply vehicle or a further delivery vehicle, is possible. An integrated battery module unit describes a battery module unit integrated in the transport device. The integrated battery module unit is integrated, for example, in the floor area of the transport device to achieve a low center of gravity of the transport device. The first interface to be received in the at least one of the first plurality of receiving units which is arranged in the cargo area is preferably configured such that it can be latched or clicked into the receiving unit to produce the connection therewith. This is particularly preferable in that the first interface may be connected to the receiving unit by moving the transport device into the cargo area, i.e. additional steps are preferably not required to produce the connection.

In an exemplary embodiment, the integrated battery module unit comprises at least one battery module installed in the transport device in a fixed manner. In addition to or instead of this, in a further embodiment, the integrated battery module unit may have a third plurality of receiving units for replaceable battery modules. This means that, in addition to or instead of a battery integrated in the transport device in a fixed manner, the transport device has receiving units for replaceable battery modules.

In a further exemplary embodiment, the integrated battery module unit of the at least one transport device moreover has a second interface for producing an electrical connection with a further first interface of a further integrated battery module unit of a further transport device. It is thus possible to electrically and mechanically connect battery module units of multiple transport devices to one another in a series circuit. This provides the option, for example, of being able to adapt the available electric energy storage capacity for the delivery vehicle in a simple manner.

In a further exemplary embodiment, the supply vehicle also has a cargo area for receiving consignments and at least one of the second plurality of receiving units for replaceable battery modules is arranged in the cargo area of the supply vehicle, which receiving unit is designed to receive an interface of the integrated battery module unit of the at least one transport device. Provision is made for the cargo area of the supply vehicle to also be able to receive one or more mutually connected transport devices, wherein the electrical connection produced serves, in particular, for charging the battery modules (which are either integrated in the transport devices in a fixed manner or replaceably incorporated in the battery module units).

According to a second aspect of the invention, a method for operating a control device of a system for supplying a delivery vehicle with electric energy according to the first aspect of the invention includes ascertaining a likely energy requirement of an electrically drivable delivery vehicle for making a plurality of successive delivery trips, in each case for transporting consignments on a respective delivery route from a starting point of the delivery route to recipients of the consignments, taking into account a subsequent delivery route and a likely total weight of the delivery vehicle after loading consignments to be delivered on the subsequent delivery route at the starting point of the subsequent delivery route, wherein the delivery vehicle has a plurality of receiving units for replaceable battery modules for supplying the delivery vehicle with electric energy. The method moreover comprises prompting a supply vehicle for delivering replaceable battery modules to meeting points with the delivery vehicle to deliver a set of replacement battery modules to a subsequent meeting point, which is the starting point of the subsequent delivery route, wherein the set of replaceable battery modules has a total charge level at the subsequent meeting point which covers at least the likely energy requirement and the set of replaceable battery modules has the lightest weight possible.

According to a third aspect of the invention, a computer program product comprises code sections which, when executed by a processor of a programmable unit of a control device of a system according to the first aspect of the invention, prompt the control device to carry out a method according to the second aspect of the invention. The code sections, i.e. the program code, of the computer program product correspond to a computer program which comprises commands with which the control device is prompted to carry out steps of the method. The programmable unit of the control device comprises at least one processor and one memory here.

According to a fourth aspect of the invention, a computer-readable data carrier comprises a computer program product according to the third aspect of the invention. A computer-readable data carrier may be both a computer-readable storage medium and a data carrier signal. A computer-readable storage medium is a medium suitable for storing software, for example a CD ROM, a DVD, a Blu-Ray disk, a USB stick, a hard drive etc. A data carrier signal enables a wired or wireless transmission of the code sections.

The advantages and special features of the system according to the invention for supplying a delivery vehicle with electric energy, including its embodiments, are therefore also realized within the context of a method for supplying a delivery vehicle with electric energy and a computer program product and a computer-readable data carrier.

### BRIEF DESCRIPTION OF THE DRAWINGS

Further advantages of the present invention can be found in the detailed description and the drawings. The invention is also explained in more detail below in conjunction with the following description of exemplary embodiments with reference to the accompanying drawings, in which:

FIG. 1 shows a schematic illustration of an example of a system for supplying a delivery vehicle with electric energy according to an embodiment of the invention;

FIG. 2 shows a schematic illustration of a supply vehicle and first and a second delivery vehicle of a system for supplying a delivery vehicle with electric energy according to a further embodiment of the invention;

FIG. 3 shows a schematic illustration of a first and a second delivery vehicle of a system for supplying a delivery vehicle with electric energy according to a further embodiment of the invention;

FIG. 4 shows a schematic illustration of a supply vehicle and a delivery vehicle of a system for supplying a delivery vehicle with electric energy according to a further embodiment of the invention; and

FIG. 5 shows a schematic illustration of an example of a method for operating a control device of a system for supplying a delivery vehicle with electric energy according to yet a further embodiment of the invention.

In the figures, identical or similar reference signs denote identical or similar elements, unless indicated otherwise.

### DETAILED DESCRIPTION

It goes without saying that other embodiments may be used and structural or logical changes made without deviating from the scope of protection of the present invention. It goes without saying that the features of the different exemplary embodiments described above and below may be combined with one another unless specifically indicated otherwise. The description should therefore not be interpreted in a restrictive sense and the scope of protection of the present invention will be defined by the accompanying claims.

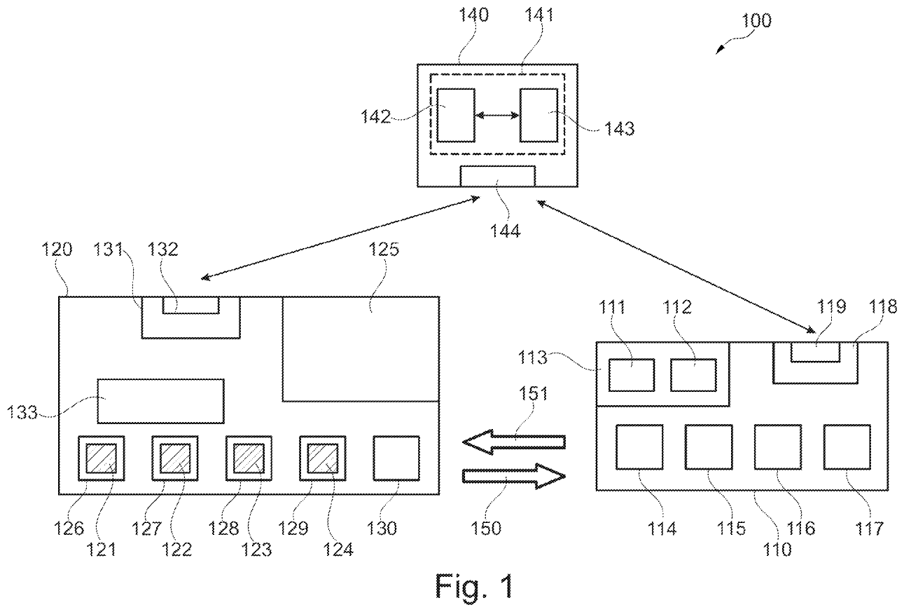

FIG. 1 shows a schematic illustration of an example of a system 100 for supplying a delivery vehicle with electric energy according to an embodiment of the invention. The illustrated system 100 comprises an electrically drivable delivery vehicle 110 for making a plurality of successive delivery journeys. Each delivery journey takes place to transport consignments 111, 112 on a respective delivery route from a starting point of the delivery route to recipients of the consignments in each case. The system 100 moreover comprises a supply vehicle 120 for delivering replaceable battery modules 121, 122, 123, 124 to meeting points with the delivery vehicle 110. A system having a delivery vehicle 110 and a supply vehicle 120 is shown. However, provision may also be made for the system to comprise multiple delivery vehicles and/or multiple supply vehicles. One supply vehicle here may also supply multiple delivery vehicles with charged battery modules, or different supply vehicles may supply one delivery vehicle with the required new set of charged battery modules in each case, e.g. before different delivery journeys of the successive delivery journeys.

The system 100 moreover comprises a control device 140, which is designed to ascertain a likely energy requirement of the delivery vehicle 110 for a subsequent delivery journey of the plurality of successive delivery journeys, taking into account a subsequent delivery route and a likely total weight of the delivery vehicle 100 at the starting point of the subsequent delivery route. The likely total weight after loading consignments 111, 112 to be delivered on the subsequent delivery route is ascertained here. The loading of consignments 111, 112 may take place manually or in an automated manner. To load the delivery vehicle 110 at the starting point of the subsequent delivery route, consignments 111, 112 are loaded into its cargo area 113. The consignments 111, 112 may have been delivered in a cargo area 125 of the supply vehicle 120, for example.

The control device 140 is moreover designed to prompt the supply vehicle 120 to deliver a set of replaceable battery modules 121, 122, 123, 124 to the starting point of the subsequent delivery route as the subsequent meeting point. Provision is made here for the delivery vehicle 120 to have multiple receiving units 126, 127, 128, 129, 130 for replaceable battery modules for supplying the delivery vehicle 110 with electric energy and for the set of replaceable battery modules 121, 122, 123, 124 to have a total charge level at the subsequent meeting point which covers at least the likely energy requirement ascertained by the control device 140 and for the set of replaceable battery modules 121, 122, 123, 124 to have the lightest weight possible. In the example shown in FIG. 1, the set of replaceable battery modules 121, 122, 123, 124 which is delivered by the delivery vehicle and has the lightest weight possible—i.e. the lightest possible total weight of the delivered set of replaceable battery modules-comprises four battery modules which are connected to a charging device 133 of the supply vehicle 120 in the receiving units 126, 127, 128, 129. The charging device may be, for example, a high voltage battery with a high energy storage capacity or a fuel cell device with a hydrogen tank. A fifth receiving unit 130 of the supply vehicles 120 is left empty in the example shown in FIG. 1. At the meeting point with the delivery vehicle, the transfer 150 of the requested set of replaceable battery modules 121, 122, 123, 124 to the delivery vehicle 110 takes place in order for them to be inserted into the four receiving units 114, 115, 116, 117 of the delivery vehicle 110. Conversely, the transfer 151 of a discharged set of replaceable battery modules (not illustrated) previously used on board the delivery vehicle 110 may take place.

In the system 100 in FIG. 1, the control device 140 is designed to be separate both from the delivery vehicle 110 and from the supply vehicle 120, and communication between the delivery vehicle 110 and the supply vehicle 120 takes place via the control device 140, which moreover calculates the subsequent delivery routes of the delivery vehicle 110 in each case and ascertains the likely energy requirement of the delivery vehicle 110 for the respective delivery journey on the respective delivery route in each case and determines which replaceable battery module should be delivered to the delivery vehicle 110 by the supply vehicle 120, and with which charge level, i.e. with which level of stored electric energy, so that, on the one hand, the set of replaceable battery modules selected in this way has a total charge level at the subsequent meeting point which is able to cover the likely energy requirement in each case and, on the other, the set of replaceable battery modules, i.e. the combination of available replaceable battery modules, is selected so that this likely energy requirement is covered by the combination of battery modules which, together, have the lightest weight possible.

In one embodiment, if all the available replaceable battery modules which may be delivered by the supply vehicle have the same weight and maximal energy storage capacity, the number of battery modules required must be ascertained provided there is sufficient time remaining to charge this set of battery modules accordingly before the transfer at the meeting point. If this is not the case, a different combination of replaceable battery modules, but with a sufficient total charge level at the time of transfer, may also create the set of replaceable battery modules with the lightest weight possible for this situation.

The control device 140 has at least one programmable unit 141, at least with a processor 142 and a memory 143, with a computer program product which comprises code sections which, when executed by the processor 142 of the programmable unit 141, prompt the control device 140 to retrieve the required parameter values of the delivery vehicle 110 and of the supply vehicle via a communications interface 144 and to carry out the required calculations. For example, to retrieve required information, further data sources (not illustrated), e.g. databases, may be accessed via the communications interface 144, for example data sources for cartographic and topographic information, current weather information and traffic information, contract and address information of recipients, locations of warehouses for the consignments etc.

In the system illustrated in FIG. 1, the delivery vehicle 110 has an on-board delivery vehicle control unit 119 with a delivery vehicle communications interface 119 and is designed to communicate wirelessly with the control unit via this. The supply vehicle 120 also has an on-board supply vehicle control unit 131 with a supply vehicle communications interface 132 and is designed to communicate wirelessly with the control unit 140 via this. In other embodiments, provision may also be made for the supply vehicle control unit 131 and/or the delivery vehicle control unit 118 to assume some or all functions of the control device 140, which is provided separately in FIG. 1, for example via a cloud computing service.

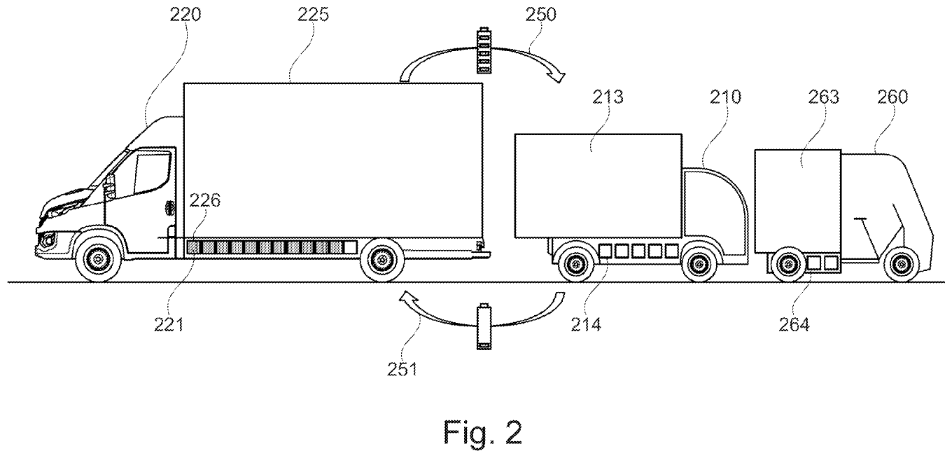

A corresponding control device of the system and corresponding control units of the vehicles are, in each case, also present in the system of the vehicles shown in the following FIGS. 2, 3 and 4, although they are not shown for reasons of clarity.

FIG. 2 shows a schematic illustration of a supply vehicle and a first and a second delivery vehicle of a system for supplying a delivery vehicle with electric energy according to a further embodiment of the invention. The supply vehicle 220 here is designed as a transport vehicle with a large cargo area 225 in which consignments which may be provided for further distribution to multiple delivery vehicles may also be transported to meeting points, in this case via a first delivery vehicle 210 and a second delivery vehicle 260. The first delivery vehicle 210 and the second delivery vehicle 260 in FIG. 2 are intended to serve as final delivery vehicles for the “last mile” to recipients of consignments and are designed as different types of light electric freight vehicles (LEFV). The two delivery vehicles 210, 260 differ, for example, both in the size of their respective cargo areas 213, 263 and in the number of their receiving units for replaceable battery modules, wherein the receiving units both of the delivery vehicles 210, 260 and the supply vehicle 220 are suitable for battery modules of a similar standardized type here. In FIG. 2, the first delivery vehicle 210 has, by way of example, five receiving units 214 for replaceable battery modules and the second delivery vehicle 260 has two receiving units 264 for replaceable battery modules, via which delivery vehicles may be supplied with the electric energy for driving them. The supply vehicle 220 has, by way of example, twelve receiving units 226 for replaceable battery modules, of which eleven are occupied by replaceable battery modules 221, wherein the supply vehicle has charged each of these to a required charge level during the journey via a charging device (not shown). The eleven provided battery modules are sufficient to incorporate a first set of replaceable battery modules for supplying the first delivery vehicle 210 and also a second set of replaceable battery modules for supplying the second delivery vehicle 260. The transfer 250 of two requested sufficiently charged sets of replaceable battery modules to the two delivery vehicles 210, 260 and the transfer 251 of two at least partially discharged sets of replaceable battery modules (not shown) previously used on board the delivery vehicles 210, 260 take place at the meeting point, which is the starting point both of a subsequent delivery route of the first delivery vehicle 210 and a further subsequent delivery route of the second delivery vehicle 26.

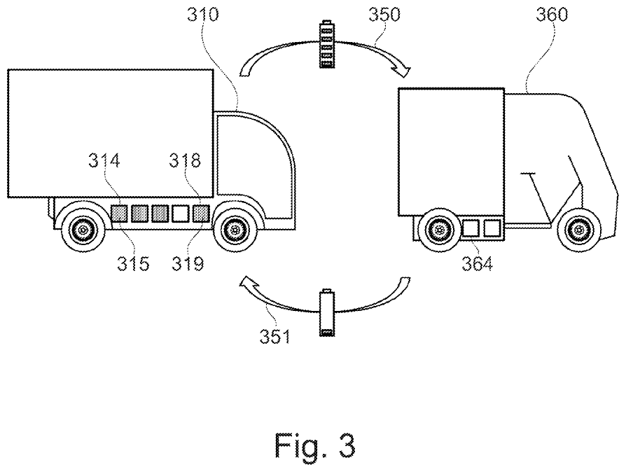

FIG. 3 shows a schematic illustration of a first and a second delivery vehicle of a system for supplying a delivery vehicle with electric energy according to a further embodiment of the invention. This illustrates that supplying charged replaceable battery modules does not have to be limited to transferring a set of requested charged battery modules from a supply vehicle to a delivery vehicle. In the embodiment shown, a first delivery vehicle 310 has four receiving units 314 for replaceable battery modules, of which three are occupied by replaceable battery modules 315 provided for driving the first delivery vehicle 310. The first delivery vehicle 310 moreover has an additional receiving unit 318 with a charged additional replaceable battery module 319. If, for example, in the case of a second delivery vehicle 360, a malfunction of a replaceable battery module occurs or the amount of energy consumed is unexpectedly greater than the originally planned energy requirement, for example due to unexpected diversions, a transfer 350 of the charged additional replaceable battery module 319 between the second delivery vehicle 360 and the first delivery vehicle 310 may take place at any desired meeting point so that the second delivery vehicle 360 can have this inserted into one of its receiving units 364 for replaceable battery modules and may then continue its delivery journey. The transfer 351 of at least one discharged battery module to the first delivery vehicle 310 is also an option.

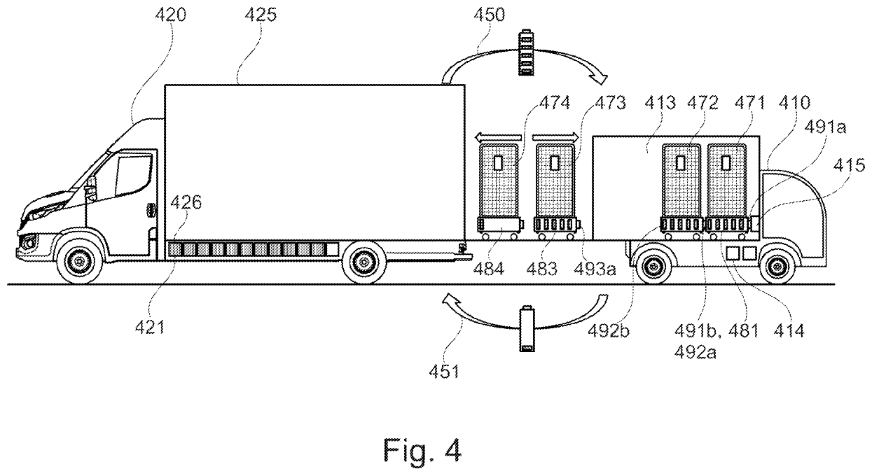

FIG. 4 shows a schematic illustration of a supply vehicle and a delivery vehicle of a system for supplying a delivery vehicle with electric energy according to a further embodiment of the invention.

The delivery vehicle 410 shown in FIG. 4 is similar to the first delivery vehicle 210 shown in FIG. 2. However, in the case of the delivery vehicle 410 shown in FIG. 4, provision is made for only two receiving units 414 for replaceable battery modules to be integrated in the chassis of the delivery vehicle 410 instead of five receiving units 214, as shown by way of example in FIG. 2. Instead, the delivery vehicle 410 has a further receiving unit 415 for replaceable battery modules, which is arranged in the cargo area 413 of the delivery vehicle 410. Provision is moreover made for consignments to be transported in transport devices in the cargo area. A first transport device 471 for consignments has a first battery module unit 481, which is integrated in the first transport device 471 and has a first interface 491a to be received in the further receiving unit 415 arranged in the cargo area 413. The charged first integrated battery module unit 418 is at least electrically connected to the delivery vehicle 410 in a releasable manner via this first interface and may output electric energy for driving the delivery vehicle 410. In addition, the first integrated battery module unit 481 may have a second interface 491b, via which it is at least electrically connected to a first interface 492a of a charged second battery module unit 482 of a second transport device 472 in a releasable manner.

In the example illustrated in FIG. 4, provision is made for the transport devices to be designed as transport carts, which may be delivered from a supply vehicle 420 having a cargo area 425 to a meeting point, wherein provision is preferably made for the cargo areas 425, 413 of the supply vehicle 420 and the delivery vehicle 410 to be configured—e.g. to be accessible via suitable loading ramps-so that the transport carts may be rolled (or driven via integrated auxiliary motors) directly from one cargo area into the other. In the situation shown in FIG. 4, as part of the transfer 450 of charged battery modules, a third transport device 473 with a charged third integrated battery module unit 483 is moved into the cargo area 413 of the delivery vehicle 410 in order to at least electrically connect its first interface 493a to the second interface 492b of the battery module unit 482 of the second transport device there. As part of the transfer 451 of discharged battery modules to the supply vehicle 420, in the situation shown in FIG. 4, a fourth transport device 474 with a discharged fourth integrated battery module unit 484 is moved into the cargo area 425 of the supply vehicle 420. In addition, the supply vehicle 420 in the example shown has, integrated in the chassis of the supply vehicle 420, twelve receiving units 426 for replaceable battery modules of which, by way of example, replaceable battery modules 421 are arranged in eleven receiving units.

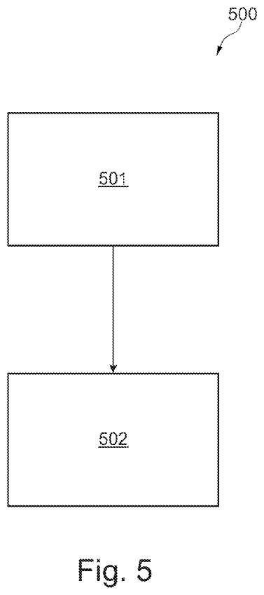

FIG. 5 shows a schematic illustration of an example of a method for operating a control device of a system for supplying a delivery vehicle with electric energy according to yet a further embodiment of the invention shown. The method 500 is suitable, for example, for operating a control device of a system for supplying a delivery vehicle with electric energy as shown in FIG. 1.

In the method 500, a likely energy requirement of an electrically drivable delivery vehicle for making a plurality of successive delivery journeys, in each case for transporting consignments on a respective delivery route from a starting point of the delivery route to recipients of the consignments, is ascertained in a first step 501, taking into account a subsequent delivery route and a likely total weight of the delivery vehicle after loading consignments to be delivered on the subsequent delivery route at the starting point of the subsequent delivery route, wherein the delivery vehicle has a plurality of receiving units for replaceable battery modules for supplying the delivery vehicle with electric energy.

In a second step 502, a supply vehicle for delivering replaceable battery modules to meeting points with the delivery vehicle is then at least prompted to deliver a set of replaceable battery modules to a subsequent meeting point, which is the starting point of the subsequent delivery route, wherein the set of replaceable battery modules has a total charge level at the subsequent meeting point which covers at least the likely energy requirement and the set of replaceable battery modules has the lightest weight possible. Depending, for example, on the number of delivery routes to be ascertained and transfers of sets of replaceable battery modules to be carried out, the steps of the method are also repeated entirely or in part.

The classification of the terms mentioned as “first”, for example “first plurality of receiving units”, merely serves to differentiate them from subsequently mentioned “second”, “third” or “further” units thereof, or similar types, and does not imply any prioritization unless explicitly indicated.

### LIST OF REFERENCE SIGNS

100 System for supplying a delivery vehicle with electric energy
110 Delivery vehicle
111 Consignment
112 Consignment
113 Cargo area
114 Receiving unit
115 Receiving unit
116 Receiving unit
117 Receiving unit
118 Delivery vehicle control unit
119 Delivery vehicle communications interface
120 Supply vehicle
121 Replaceable battery module
122 Replaceable battery module
123 Replaceable battery module
124 Replaceable battery module
125 Cargo area
126 Receiving unit
127 Receiving unit
128 Receiving unit
129 Receiving unit
130 Receiving unit
131 Supply vehicle control unit
132 Supply vehicle communications interface
133 Charging device
140 Control device
141 Programmable unit
142 Processor
143 Memory
144 Communications interface
150 Transfer of the charged set of replaceable battery modules
151 Transfer of a discharged set of replaceable battery module
210 First delivery vehicle
213 Cargo area
214 Receiving unit
220 Supply vehicle
221 Replaceable battery module
225 Cargo area
226 Receiving unit
250 Transfer of two sets of charged battery modules
251 Transfer of two sets of discharged battery modules
260 Second delivery vehicle
263 Cargo area
264 Receiving unit
310 First delivery vehicle
314 Receiving unit
315 Replaceable battery module
318 Additional receiving unit
319 Additional replaceable battery module
350 Transfer of the additional replaceable battery module
351 Transfer of at least one discharged battery module
360 Second delivery vehicle
364 Receiving unit
410 Delivery vehicle
413 Cargo area
414 Receiving unit
415 Receiving unit
420 Supply vehicle
421 Replaceable battery module
425 Cargo area
426 Receiving unit
450 Transfer of charged battery modules
451 Transfer of discharged battery modules
471 Transport device
472 Transport device
473 Transport device
474 Transport device
481 Battery module unit
482 Battery module unit
483 Battery module unit
484 Battery module unit
491a First interface
491b Second interface
492a First interface
492b Second interface
493a First interface
500 Method for operating a control device of a system for supplying a delivery vehicle with electric energy
501 Step
502 Step

That which is claimed is:

1. A system for supplying a delivery vehicle with electric energy, comprising
an electrically drivable delivery vehicle for making a plurality of successive delivery journeys, in each case for transporting consignments on a respective delivery route from a starting point of the delivery route to recipients of the consignments;
a supply vehicle for delivering replaceable battery modules to meeting points with the delivery vehicle; and
a control device, which is designed to ascertain a likely energy requirement of the delivery vehicle for a subsequent delivery journey of the plurality of successive delivery journeys, taking into account a subsequent delivery route and a likely total weight of the delivery vehicle after loading consignments to be delivered on the subsequent delivery route at the starting point of the subsequent delivery route, and to prompt the supply vehicle to deliver a set of replaceable battery modules to a subsequent meeting point, which is the starting point of the subsequent delivery route,
wherein the delivery vehicle has a first plurality of receiving units for replaceable battery modules for supplying the delivery vehicle with electric energy, and the set of replaceable battery modules has a total charge level at the subsequent meeting point which covers at least the likely energy requirement and the set of replaceable battery modules has the lightest weight possible.

2. The system according to claim 1, wherein the supply vehicle is designed to also deliver at least some of the consignments to be delivered on the subsequent delivery route of the delivery vehicle.

3. The system according to claim 1, wherein the supply vehicle has a second plurality of receiving units for replaceable battery modules.

4. The system according to claim 1, wherein the supply vehicle has a charging device, which is designed to charge replaceable battery modules with electric energy during the journey and when the supply vehicle is stationary.

5. The system according to claim 1, wherein the supply vehicle has a fuel cell device and is designed to generate electric energy via the fuel cell device to charge the replaceable battery module.

6. The system according to claim 5, wherein the supply vehicle is a fuel cell vehicle (FCEV) and is itself powered by the fuel cell device or a further fuel cell device.

7. The system according to claim 1, wherein the replaceable battery modules are of a similar standard type.

8. The system according to claim 1, wherein the supply vehicle is designed to deliver replaceable battery modules to at least one further delivery vehicle.

9. The system according to claim 1, wherein the set of replaceable battery modules can be operated in a low voltage range.

10. The system according to claim 1, wherein the control device is designed to create the set of replaceable battery modules taking into account the optimization of the life of the replaceable battery modules.

11. The system according to claim 1, further comprising:
at least one further electrically drivable delivery vehicle for making a further plurality of successive delivery journeys, in each case for transporting further consignments on a respective further delivery route from a further starting point of the further delivery route to recipients of the further consignments.

12. The system according to claim 11, further comprising:
at least one further supply vehicle for delivering further replaceable battery modules to further meeting points with the delivery vehicle and/or the at least one further delivery vehicle.

13. The system according to claim 12, wherein the control device is designed to manage the assignment of the battery modules to vehicles of the system.

14. The system according to claim 1, wherein the delivery vehicle has, in addition to the first plurality of receiving units for replaceable battery modules for supplying the delivery vehicle with electric energy, at least one additional receiving unit for replaceable battery modules.

15. The system according to claim 1, wherein the delivery vehicle has a cargo area for receiving the consignments and at least one of the first plurality of receiving units for replaceable battery modules is arranged in the cargo area.

16. The system according to claim 15, comprising at least one transport device for consignments, wherein the at least one transport device is designed to be received in the cargo area and has an integrated battery module unit, which has a first interface to be received in the least one of the first plurality of receiving units for replaceable battery modules, which receiving unit is arranged in the cargo area.

17. The system according to claim 16, wherein the integrated battery module unit comprises at least one battery module installed in the transport device in a fixed manner.

18. A method for operating a control device of a system for supplying a delivery vehicle with electric energy, comprising:
ascertaining a likely energy requirement of an electrically drivable delivery vehicle for making a plurality of successive delivery journeys, in each case for transporting consignments on a respective delivery route from a starting point of the delivery route to recipients of the consignments, taking into account a subsequent delivery route and a likely total weight of the delivery vehicle after loading consignments to be delivered on the subsequent delivery route at the starting point of the subsequent delivery route, wherein the delivery vehicle has a plurality of receiving units for replaceable battery modules for supplying the delivery vehicle with electric energy; and
prompting a supply vehicle for delivering replaceable battery modules to meeting points with the delivery vehicle to deliver a set of replacement battery modules to a subsequent meeting point, which is the starting point of the subsequent delivery route, wherein the set of replaceable battery modules has a total charge level at the subsequent meeting point which covers at least the likely energy requirement and the set of replaceable battery modules has the lightest weight possible.

19. The method of claim 18, further comprising causing the charging of the replaceable battery modules with electric energy during the journey or when the supply vehicle is stationary.

20. The method of claim 18, wherein ascertaining a likely energy requirement of an electrically drivable delivery vehicle for making a plurality of successive delivery journeys further comprising taking into account the optimization of the life of the replaceable battery modules.
